(19) United States
(12) Patent Application Publication
(10) Pub. No.: US 2012/0127151 A1
(43) Pub. Date: May 24, 2012

(54) POWER SUPPLY DEVICE, LIQUID CRYSTAL DRIVE DEVICE, AND LIQUID CRYSTAL DISPLAY DEVICE

(75) Inventor: Kazuhiro Murakami, Kyoto (JP)

(73) Assignee: ROHM CO., LTD., Kyoto (JP)

(21) Appl. No.: 13/298,381

(22) Filed: Nov. 17, 2011

(30) Foreign Application Priority Data
Nov. 19, 2010 (JP) 2010-259290

(51) Int. Cl. G09G 3/36; G06F 3/038; G05F 1/00

(52) U.S. Cl. 345/212; 323/265; 345/87

(57) ABSTRACT

The power supply device according to the present invention comprises a first power supply circuit arranged to generate a first output voltage from an input voltage; and a second power supply circuit arranged to generate from the input voltage a second output voltage that is less than the first output voltage, wherein the first power supply circuit performs feedback control of the first output voltage so as to cause a first feedback voltage that corresponds to the first output voltage to match a predetermined reference voltage; and the second power supply circuit performs feedback control of the second output voltage so as to cause a second feedback voltage that corresponds to the second output voltage to match the first feedback voltage.

### CROSS-REFERENCE TO RELATED APPLICATIONS

This application is based on Japanese Patent Application No. 2010-259290 filed on Nov. 19, 2010, the contents of which are hereby incorporated by reference.

### BACKGROUND OF THE INVENTION

1. Field of the Invention

The present invention relates to a power supply device for generating output voltage for two systems having different voltage values, and to a liquid crystal drive device and a liquid crystal display device that use the power supply device.

2. Description of Related Art

FIG. 3 is a block diagram showing a conventional example of a liquid crystal display device. In recent years, a scheme for driving a source driver IC 300 using a two-system power supply voltage having different voltage values (output voltage VO1 of a step-up power supply IC100 (e.g., 15 V), and output voltage VO2 of a step-down power supply IC200 (e.g., 7.5 V)) has come into more widespread use mainly for saving energy and reducing heat output of a source driver IC 300 which supplies a source voltage to a liquid crystal display (LCD) panel 400, as shown by the present conventional example.

For example, among the drive steps (amplifiers) included in the source driver IC300, half are driven between the output voltage VO1 and the output voltage VO2, and the remaining half are driven between the output voltage VO2 and ground voltage GND.

Japanese Laid-open Patent Application No. 2006-171367 is an example of prior art related to the above.

However, the source driver IC 300 is liable to be damaged due to incompatibility in start/stop timing between the output voltage VO1 and output voltage VO2 inputted thereto (a state in which only the output voltage VO1 or the output voltage VO2 is outputted, or another state), or due to a deficiency in withstand voltage of the drive step when the voltage values are in an inverted state even for a moment.

The problems noted above will be specifically described with reference to FIG. 4. FIG. 4 is a timing chart for describing conventional problems, and the change in the output voltages VO1 and VO2 over time is shown in the form of a graph. Three different types of behavior of the output voltage VO2 are depicted by a solid line (ideal behavior with perfect synchronization with the output voltage VO1), a single-dot chain line (behavior in the case that the rise is slower than the output voltage VO1), and a two-dot chain line (behavior in the case of startup earlier than the output voltage VO1).

In the step-up power supply IC 100, a load switch P1 is switched off at time t21 or earlier so that an input voltage V1 (e.g., 12 V) is not output as the output voltage VO1. At time t21, the load switch P1 is soft-on controlled so that conductivity is gradually increased when the load switch P1 is switched on. When the operation for stepping up the input voltage V1 is thereafter started, the output voltage VO1 becomes higher than the input voltage V1, and at time t22, the output voltage VO1 reaches a target value (e.g., 15 V).

On the other hand, in the step-down power supply IC 200, the operation for outputting the output voltage VO2 is started at time t21 in the case that the output voltage VO2 exhibits the behavior of the solid line, and the output voltage VO2 reaches the target value (e.g., 7.5 V) at time t22. Therefore, as long as the output voltage VO2 exhibits the behavior of the solid line, there is no incompatibility of the start/stop timings between the output voltage VO1 and the output voltage VO2, an inverted state of the voltage values does not occur, and consequently, a deficiency in the withstand voltage of the source driver IC 300 does not occur.

However, in the case that the output voltage VO2 exhibits the behavior of the single-dot chain line, i.e., a state in which the output voltage VO2 slowly rises and the output voltage VO2 has not yet reached the target value (7.5 V), an unexpected high voltage (e.g., 7.5 V or higher) is applied to the source driver IC 300 in the case that the output voltage VO1 has reached its target value (15 V) first, and damage is liable to occur due to insufficient withstand voltage. In the case that the output voltage VO2 exhibits the behavior of the two-dot chain line, i.e., in the case that the output voltage VO2 has started earlier than the output voltage VO1, an unexpected reverse electric current flows to the source driver IC 300 and damage is liable to occur due to overcurrent.

The simplest countermeasure for avoiding such damage would seem to be to increase the withstand voltage of the drive step of the source driver IC 300. However, such an avoidance measure leads to higher cost and larger chip size of the source driver IC 300, and therefore cannot be said to be the best avoidance measure. On the other hand, it is possible to avoid the above-described damage without unnecessarily increasing the withstand voltage of the drive step of the source driver IC 300 provided that the soft-start behaviors between the step-up power supply IC 100 and the step-down power supply IC 200 can be perfectly synchronized. However, with the liquid crystal display device of the above-described conventional example, the output voltages VO1 and VO2 are generated by separate ICs, and in order to cause the start and stop sequences of the two voltages to match with high precision, the precision of the capacitors Css1, Css2 for soft-start control mounted external to the power supply ICs must be increased, or the precision of the charge current for charging these capacitors must be increased. Therefore, extra pins, external resistance, and other components must be added to the power supply ICs.

### SUMMARY OF THE INVENTION

In view of the above-described problems found by the present inventors, a main object of the present invention is to provide a power supply device in which incompatibility of start/stop timings between the output voltages and an inversion of voltage values are avoided without increasing the number of pins and external parts, in the case that output voltage is generated for two systems having different voltage values; and to provide a liquid crystal drive device and a liquid crystal display device that use the power supply device.

In order to achieve the above-stated objects, the power supply device according to the present invention comprises: a first power supply circuit arranged to generate a first output voltage from an input voltage; and a second power supply circuit arranged to generate from the input voltage a second output voltage that is less than the first output voltage, wherein the first power supply circuit performs feedback control of the first output voltage so as to cause a first feedback voltage that corresponds to the first output voltage to match a predetermined reference voltage; and the second power supply circuit performs feedback control of the second output voltage so as to cause a second feedback voltage that corresponds to the second output voltage to match the first feedback voltage.

Further features, elements, steps, advantages, and characteristics of the present invention will become apparent from the description of preferred embodiments given below and from the attached drawings related to the preferred embodiments.

### BRIEF DESCRIPTION OF THE DRAWINGS

FIG. 1 is a block diagram showing a configuration example of the liquid crystal display device according to the present invention;

FIG. 2 is a timing chart showing the start sequence of the output voltages VO1 and VO2;

FIG. 3 is a block diagram showing a conventional example of a liquid crystal display device; and

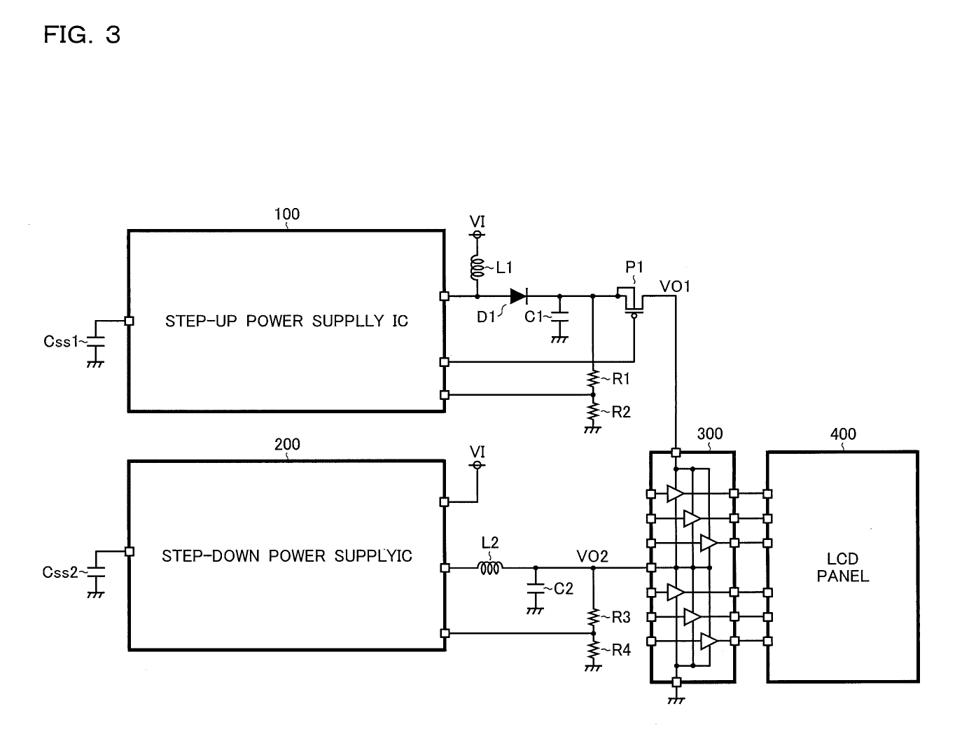

FIG. 4 is a timing chart for describing conventional problems.

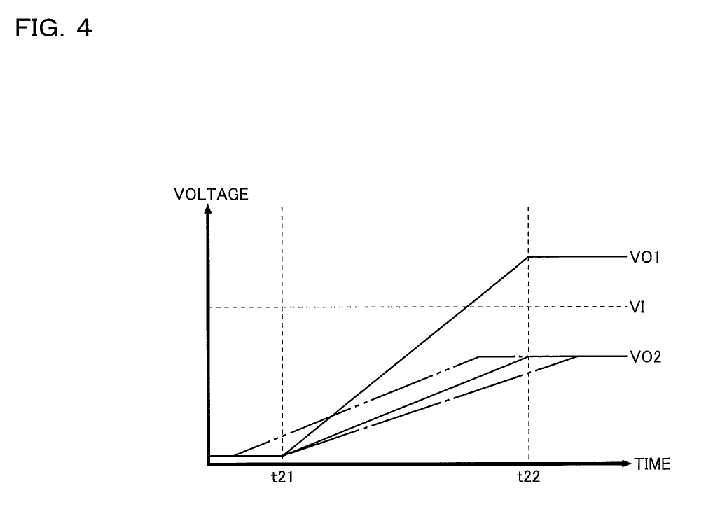

### DETAILED DESCRIPTION OF PREFERRED EMBODIMENTS

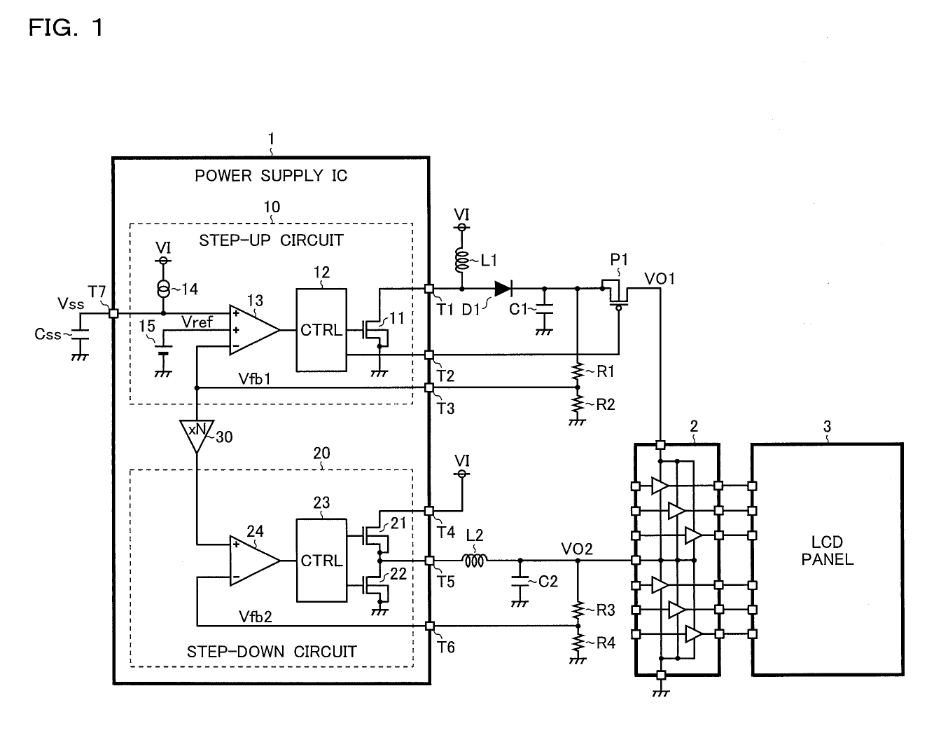

FIG. 1 is a block diagram showing a configuration example of the liquid crystal display device according to the present invention. The liquid crystal display device of the present configuration example has a power supply IC 1, a source driver IC 2, and an LCD panel 3; and additionally has as discrete components mounted external to the power supply IC 1: inductors L1, L2, a diode D1, capacitors C1, C2, Css, resistors R1, R2, R3, R4 and a P-channel metal oxide semiconductor (MOS) field effect transistor P1.

The power supply IC 1 is a semiconductor integrated circuit device for generating output voltages VO1 and VO2 for two systems having different voltage values, and has a step-up circuit 10, a step-down circuit 20, and a gain amplifier 30. The power supply IC 1 also has at least pins T1 to T7 for providing an external electrical connection.

The step-up circuit 10 is a power supply circuit for stepping up the input voltage V1 (e.g., 12 V) to generate the output voltage VO1 (e.g., 15 V), and has an N-channel MOS field effect transistor 11, a controller 12, an error amplifier 13, a constant current supply 14, and a direct current voltage supply 15.

The transistor 11 is an output transistor which is controlled to an on or off state by the controller 12. The drain of the transistor 11 is connected to the pin T1. The source and back gate of the transistor 11 are both connected to a ground terminal. The gate of the transistor 11 is connected to the controller 12.

The controller 12 is a logic circuit for controlling the transistor 11 to an on or off state so that an error voltage outputted from the error amplifier 13 is reduced. The internal configuration of the controller 12 can be a common configuration in which a pulse width modulation (PWM) signal is generated by, e.g., comparing the error voltage and a triangular wave-shaped strobe voltage, and generating a gate signal of the transistor 11 using the PWM signal.

The error amplifier 13 generates an error voltage by amplifying a difference between a feedback voltage Vfb1 and the lower of a reference voltage Vref and a soft-start voltage Vss. A first non-inverting input terminal (+) of the error amplifier 13 is connected to pin T7. A second non-inverting input terminal (+) of the error amplifier 13 is connected to a positive terminal (the terminal to which the reference voltage Vref is applied) of the direct current voltage supply 15. The negative terminal of the direct current voltage supply 15 is connected to a ground terminal. An inverting input terminal (−) of the error amplifier 13 is connected to the pin T3.

The constant current supply 14 is connected between the pin T7 and the terminal to which the input voltage V1 is applied, and generates a charging voltage of the capacitor Css that is externally connected to the pin T7. Therefore, the soft-start voltage Vss that gradually steps up after the power supply IC 1 has started up appears at the pin T7. In other words, the constant current supply 14 and the capacitor Css function as a soft-start voltage generator.

The inductor L1, the diode D1, and the capacitor C1 function as an output step of the step-up circuit 10. A first terminal of the inductor L1 is connected to the terminal to which the input voltage V1 is applied. A second terminal of the inductor L1 is connected to the pin T1. The anode of the diode D1 is connected to the pin T1. The cathode of the diode D1 is connected to the first terminal of the capacitor C1. The second terminal of the capacitor C1 is connected to the ground terminal.

The transistor P1 functions as a load switch for switching the power supply route to the source driver IC 2 on and off so that the input voltage V1 is not outputted as the output voltage VO1 when the step-up circuit 10 is not being driven. The source and back gate of the transistor P1 are connected to the first terminal of the capacitor C1. The drain of the transistor P1 is connected to the first power supply input terminal of the source driver IC 2. The gate of the transistor P1 is connected to the controller 12 via the pin T2.

The resistors R1, R2 function as a feedback voltage generator for generating a feedback voltage Vfb1 that corresponds to the output voltage VO1 by dividing the output voltage VO1 in a predetermined divided voltage ratio (=R2/(R1+R2). The first terminal of the resistor R1 is connected to the first terminal of the capacitor C1. The second terminal of the resistor R1 is connected to the pin T3. The first terminal of the resistor R2 is connected to the pin T3. The second terminal of the resistor R2 is connected to the ground terminal.

In the step-up circuit 10 having the configuration described above, feedback control of the output voltage VO1 is carried out so as to cause a match between the feedback voltage Vfb1 that corresponds to the output voltage VO1 and a predetermined reference voltage Vref.

The step-down circuit 20 is a power supply circuit for stepping down the input voltage V1 to generate a output voltage VO2 (e.g., 7.5 V) that is lower than the output voltage VO1, and has an N-channel MOS field effect transistors 21, 22, a controller 23, and an error amplifier 24.

The transistor 21 is an output transistor which is controlled to an on or off state by the controller 23. The drain of the transistor 21 is connected to the pin T4. The source and back gate of the transistor 21 are both connected to the pin T5. The gate of the transistor 21 is connected to the controller 23.

The transistor 22 is a synchronizing rectifier transistor which is controlled to an on or off state in complimentary fashion (exclusively) with the transistor 21 by the controller 23. The drain of the transistor 22 is connected to the pin T5. The source and back gate of the transistor 22 are both connected to the ground terminal. The gate of the transistor 22 is connected to the controller 23. In the case that an asynchronous rectification scheme is used, a diode can be used in place of the transistor 22.

The controller 23 is a logic circuit for performing on/off control of the transistors 21, 22 so that the error voltage outputted from the error amplifier 24 is reduced. The internal configuration of the controller 23 can be a common configuration in which a PWM signal is generated by, e.g., comparing the error voltage and a triangular wave-shaped strobe voltage in the same manner as the controller 12, and generating gate signals of the transistors 21, 22 using the PWM signal.

The error amplifier 24 generates an error voltage by amplifying the difference between the feedback voltage Vfb1 of the step-up circuit 10 that is inputted via the gain amplifier 30 and a feedback voltage Vfb2 that corresponds to the output voltage VO2. A non-inverting input terminal (+) of the error amplifier 24 is connected to the output terminal of the gain amplifier 30. An inverting input terminal (−) of the error amplifier 24 is connected to the pin T6.

The inductor L2 and the capacitor C2 function as an output step of the step-down circuit 20. The pin T4 is connected to the terminal to which the input voltage V1 is applied. The first terminal of the inductor L2 is connected to the pin T5. The second terminal of the inductor L2 is connected to the first terminal of the capacitor C2, and is connected to the second power supply input terminal of the source driver IC 2. The second terminal of the capacitor C2 is connected to the ground terminal.

Resistors R3, R4 function as a feedback voltage generator for generating a feedback voltage Vfb2 that corresponds to the output voltage VO2 by dividing the output voltage VO2 in a predetermined divided voltage ratio (=R4/(R3+R4). The first terminal of the resistor R3 is connected to the first terminal of the capacitor C2. The second terminal of the resistor R3 is connected to the pin T6. The first terminal of the resistor R4 is connected to the pin T6. The second terminal of the resistor R4 is connected to the ground terminal.

In the step-down circuit 20 having the configuration described above, feedback control of the output voltage VO2 is carried out so as to cause a match between the feedback voltage Vfb2 that corresponds to the output voltage VO2 and the feedback voltage Vfb1 of the step-up circuit 10 that is inputted via the gain amplifier 30.

The gain amplifier 30 amplifies and outputs the feedback voltage Vfb1 of the step-up circuit 10 to the error amplifier 24 of the step-down circuit 20. The gain amplifier 30 is preferably a variable amplifier in which the gain N thereof can be arbitrarily and variably controlled. However, the gain amplifier 30 is not a required constituent element for implementing the present invention, and the feedback voltage Vfb1 of the step-up circuit 10 may be directly inputted to the error amplifier 24 of the step-down circuit 20.

The source driver IC 2 is a semiconductor integrated circuit device that receives supply of the output voltages VO1 and VO2 of two systems that have different voltage values, generates a source signal (video signal) having a voltage value that corresponds to the image data, and outputs the source signal to the pixels of the LCD panel 3 (more specifically, the source terminals of the active elements connected to the pixels of the LCD panel 3). For example, half of the drive steps (amplifiers) included in the source driver IC 2 are driven between the output voltage VO1 and the output voltage VO2, and the remaining half are driven between the output voltage VO2 and the ground voltage GND. The use of such a drive scheme makes it possible to implement energy savings and a reduction in heat output of the source driver IC 2 in comparison with driving the drive steps between the output voltage VO1 and the ground voltage GND.

The LCD panel 3 is thin film transistor (TFT) video output means that uses as pixels liquid crystal elements that change in optical transmissivity in accordance with the voltage value of the source single supplied from the source driver IC 2.

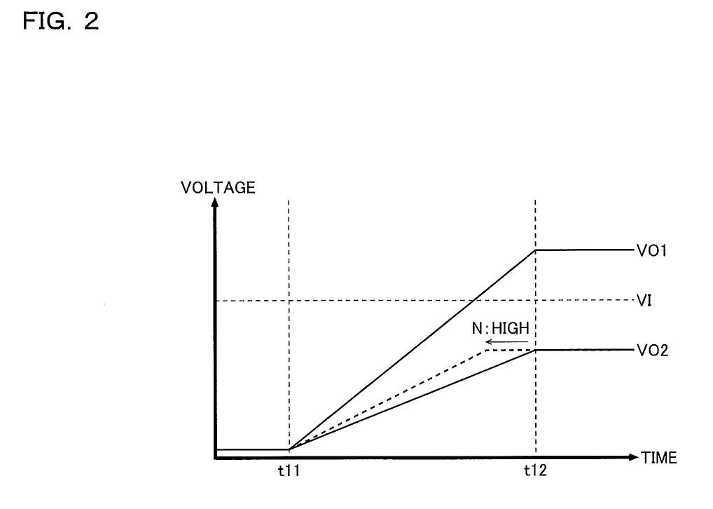

FIG. 2 is a timing chart showing the start sequence of the output voltages VO1 and VO2. As described above, in the power supply IC 1 of the present configuration example, the feedback voltage Vfb1 of the step-up circuit 10 that is used for generating the output voltage VO1 is inputted to the non-inverting input terminal (+) of the error amplifier of the step-down circuit 20 that generates the output voltage VO2, the output voltage VO1 being the higher voltage value and the output voltage VO1 being the lower voltage value of the output voltages VO1 and VO2 of two systems having different voltage values. This feedback voltage Vfb1 is used as the reference voltage for making comparative reference with the feedback voltage Vfb2 of the step-down circuit 20 to carry out feedback control of the output voltage VO2.

Such a configuration makes it possible to avoid start/stop timing mismatches and inversion of voltage values related to the output voltages VO1 and VO2 without leading to an increase in pins and externally mounted components because the step-up circuit 10 starts up and the output voltage VO1 (hence, the feedback voltage Vfb1) gradually steps up, whereupon the step-down circuit 20 which uses the output voltage VO1 as a reference voltage also starts up with the same timing, and the soft-start operation is carried out with perfect synchronization with the step-up circuit 10. Therefore, a smaller, lower cost source driver IC 2 can be obtained because the withstand voltage of the source driver IC 2 can be reduced.

In a configuration in which the feedback voltage Vfb1 of the step-up circuit 10 is outputted to the step-down circuit 20 via the gain amplifier 30, the gain N of the gain amplifier 30 is variably controlled, thereby making it possible to arbitrarily adjust the slope of the startup waveform of the output voltage VO2 in relation to the slope of the startup waveform of the output voltage VO1. For example, the gain N of the gain amplifier 30 can be adjusted so that the output voltage VO2 always reaches a target value before the output voltage VO1 does, without reliance on the specifications of the source driver IC 2 or the timing control of a load switch P1, thereby making it possible to prevent in advance a situation in which an unexpectedly high voltage (e.g., 7.5 V or higher) is applied to the source driver IC 2. Therefore, the withstand voltage of the source driver IC 2 can be reduced.

The present invention can be said to have industrial applicability as an effective technique for increasing the reliability of a power supply device for a source driver that is mounted in, e.g., a TFT liquid crystal display device.

In the embodiment described above, a configuration is described as an example in which the present invention is applied to a power supply IC 1 for generating output voltages VO1 and VO2 for a source driver IC 2 mounted in a TFT liquid crystal display device, but no limitation is imposed thereby; application can also be widely made to power supply devices in general in which start/stop timing mismatch and inversion of voltage values must be avoided when output voltage for two systems is to be generated.

In addition to the embodiments described above, the configuration of the present invention can be variously modified in a range that does not depart from the spirit of the invention. In other words, the embodiments described above are examples in all points, and should not be considered be limiting in nature. The technical range of the present invention is as disclosed in the claims and not in the description of the embodiments above, and shall be understood to include meanings equivalent to the claims as well as all modifications within the range.

1. A power supply device comprising:
a first power supply circuit arranged to generate a first output voltage from an input voltage; and
a second power supply circuit arranged to generate from the input voltage a second output voltage that is less than the first output voltage, wherein
the first power supply circuit performs feedback control of the first output voltage so as to cause a first feedback voltage that corresponds to the first output voltage to match a predetermined reference voltage; and
the second power supply circuit performs feedback control of the second output voltage so as to cause a second feedback voltage that corresponds to the second output voltage to match the first feedback voltage.

2. The power supply device of claim 1, further comprising a gain amplifier arranged to amplify and output the first feedback voltage to the second power supply circuit.

3. The power supply device of claim 2, wherein the gain amplifier is a variable gain amplifier.

4. The power supply device of claim 1, wherein the first power supply circuit comprises:
a first output transistor;
a soft-start voltage generator arranged to generate a soft-start voltage that gradually increases after start up;
a first error amplifier arranged to generate a first error voltage from the first feedback voltage and the lower of the reference voltage and the soft-start voltage; and
a first controller arranged to perform an on/off control of the first output transistor so that the first error voltage is reduced.

5. The power supply device of claim 4, wherein the second power supply circuit comprises:
a second output transistor;
an error amplifier arranged to generate a second error voltage from the first feedback voltage and the second feedback voltage; and
a second controller arranged to perform on/off control of the second output transistor so that the second error voltage is reduced.

6. The power supply device of claim 1, wherein the first power supply circuit is a step-up power supply circuit and the second power supply circuit is a step-down power supply circuit.

7. The power supply device of claim 4, wherein the first power supply circuit is a step-up power supply circuit and the second power supply circuit is a step-down power supply circuit.

8. The power supply device of claim 5, wherein the first power supply circuit is a step-up power supply circuit and the second power supply circuit is a step-down power supply circuit.

9. A liquid crystal drive device comprising:
a power supply device comprising:
a first power supply circuit arranged to generate a first output voltage from an input voltage; and
a second power supply circuit arranged to generate from the input voltage a second output voltage that is less than the first output voltage, wherein
the first power supply circuit performs feedback control of the first output voltage so as to cause a first feedback voltage that corresponds to the first output voltage to match a predetermined reference voltage, and
the second power supply circuit performs feedback control of the second output voltage so as to cause a second feedback voltage that corresponds to the second output voltage to match the first feedback voltage,
wherein the liquid crystal drive device further comprises a source driver device arranged to receive supply of the first output voltage and the second output voltage from the power supply device and generate a source signal of a liquid crystal display panel.

10. A liquid crystal display device comprising:
the liquid crystal drive device of claim 9; and
a liquid crystal display panel driven by the liquid crystal drive device.

11. The liquid crystal drive device of claim 9 wherein the power supply device further comprises a gain amplifier arranged to amplify and output the first feedback voltage to the second power supply circuit.

12. The liquid crystal drive device of claim 11 wherein the gain amplifier is a variable gain amplifier.

13. The liquid crystal drive device of claim 11, wherein the first power supply circuit comprises:
a first output transistor;
a soft-start voltage generator arranged to generate a soft-start voltage that gradually increases after start up;
a first error amplifier arranged to generate a first error voltage from the first feedback voltage and the lower of the reference voltage and the soft-start voltage; and
a first controller arranged to perform an on/off control of the first output transistor so that the first error voltage is reduced.

14. The liquid crystal drive device of claim 13 wherein the second power supply circuit comprises:
a second output transistor;
an error amplifier arranged to generate a second error voltage from the first feedback voltage and the second feedback voltage; and
a second controller arranged to perform on/off control of the second output transistor so that the second error voltage is reduced.

15. The liquid crystal drive device of claim 11 wherein the first power supply circuit is a step-up power supply circuit and the second power supply circuit is a step-down power supply circuit.

16. The liquid crystal drive device of claim 13 wherein the first power supply circuit is a step-up power supply circuit and the second power supply circuit is a step-down power supply circuit.

17. The liquid crystal drive device of claim 14 wherein the first power supply circuit is a step-up power supply circuit and the second power supply circuit is a step-down power supply circuit.
